(19) United States
(12) Patent Application Publication
(10) Pub. No.: US 2004/0084811 A1
(43) Pub. Date: May 6, 2004

(54) Method of fabricating a three-dimensional microfluidic device

(76) Inventors: David J. Beebe, Monona, WI (US); David J. Quirk, Cleveland, OH (US)

Correspondence Address: Peter C. Stomma, BOYLE, FREDRICKSON, NEWHOLM, STEIN & GRATZ S.C., Suite 1030, 250 E. Wisconsin Avenue, Milwaukee, WI, 53202, US

(21) Appl. No.: 10/286,554

(22) Filed: Nov. 1, 2002

(51) Int. Cl. B29C 35/04

(52) U.S. Cl. 264/401

(57) ABSTRACT

A method is provided for fabricating a three-dimensional device. The method includes the steps of providing a container defining a chamber and filling the chamber with a polymerizable material. Masks are positioned between a polymerizing agent and corresponding portions of polymerizable material. The polymerizing agent passes through the masks so as to polymerize selected portions of the polymerizable material within a chamber of the container and form the three-dimensional device.

### REFERENCE TO GOVERNMENT GRANT

This invention was made with United States government support awarded by the following agencies: DOD ARPA F30602-00-2-0570. The United States has certain rights in this invention.

### FIELD OF THE INVENTION

This invention relates generally to microfluidic devices, and in particular, to a method of fabricating a three-dimensional, microfluidic device using liquid phase, photo-polymerizable materials.

### BACKGROUND AND SUMMARY OF THE INVENTION

As is known, microfluidic devices are being used in an increasing number of applications. However, further expansion of the uses for such microfluidic devices has been limited due to the difficulty and expense of fabrication. By way of example, Chow, U.S. Pat. No. 6,167,910 discloses a multi-layer microfluidic device and method of making the same. The microfluidic device disclosed in the Chow '910 patent includes a body structure having a plurality of substrate layers such as a bottom substrate, a middle substrate and a top substrate. The bottom substrate includes a top surface having grooves fabricated therein in any conventional manner, such as by etching or the like. Upon the mating of the top surface of the bottom substrate with the bottom surface of the middle substrate, these grooves form a channel network for the microfluidic device. Additional channel networks may be formed by the top surface of another substrate and the bottom surface of the adjacent substrate. In such manner, multi-layer channel networks may be formed within a microfluidic device. Ports may be provided in each of the substrates to interconnect the various channel networks within the microfluidic device. It is contemplated to thermally bond the substrates together in order to form an integral, microfludic device.

While the method disclosed in the Chow '910 patent is functional for its intended purpose, the method disclosed therein has significant limitations. By way of example, each of the substrates must be preformed using traditional microfabrication methods that involve etching. These traditional methods are inherently expensive due to the equipment, materials and process complexity issues required. Further, the cost of thermally bonding the substrates together in high temperature annealing ovens increases the overall cost to manufacture the microfluidic device. As such, it is highly desirable to provide a simpler and more economical method of fabricating three-dimensional microfluidic devices.

Therefore, it is a primary object and feature of the present invention to provide a method of fabricating a three-dimensional, microfluidic device that is simple and inexpensive.

It is a further object and feature of the present invention to provide a method of fabricating a three-dimensional, microfluidic device in a shorter period of time than prior methods now practiced.

It is a still further object and feature of the present invention to provide a method of fabricating a three-dimensional, microfluidic device that may be customized to a particular application without undue additional expense.

In accordance with the present invention, a method is provided for fabricating a three-dimensional device. The method includes the steps of providing a volume of polymerizable material that has an outer surface. A polymerizing agent is directed towards a first portion of the outer surface. In addition, the polymerizing agent is directed towards a second portion of the outer surface.

A first mask may be positioned between the polymerizing agent and the first portion of the outer surface. A second mask may be positioned between the polymerizing agent and the second portion of the outer surface. In a first embodiment, the polymerizing agent is directed towards the first portion of the outer surface along the first axis and towards the second portion of the outer surface along the second axis. The first axis and the second axis are at a predetermined angle to each other. The polymerizing agent may be directed towards the first portion of the outer surface is directed by a first source and the polymerizing agent may be directed towards the second portion of the outer surface by a second source. Alternatively, the second portion of the outer surface may be repositioned prior to the step of directing the polymerizing agent towards the second portion of the outer surface such that the polymerizing agent travels along a single axis.

In accordance with a further aspect of the present invention, a method is provided for fabricating a three dimensional device. The method includes the steps of providing a container that defines a chamber. The container has an outer surface. The chamber is filled with a polymerizable material and a polymerizing agent is directed towards the container such that first and second portions of the outer surface of the container are exposed to the polymerizing agent.

A first mask may be positioned between the polymerizing agent and the first portion of the outer surface of the container. A second mask may be positioned between the polymerizing agent and the second portion of the outer surface of the container. The polymerizing agent directed towards the first portion of the outer surface travels along a first axis and the polymerizing agent directed towards the second portion of the outer surface travels along a second axis. The first axis and the second axis are at a predetermined angle to each other. It is contemplated that the polymerizing agent directed towards the first portion of the outer surface be generated by a first source and the polymerizing agent directed towards a second portion of the outer surface be generated by a second source. Alternatively, the container may be repositioned after directing the polymerizing agent towards the first portion of the outer surface of the container such that the polymerizing agent travels along a single axis.

In accordance with a further aspect of the present invention, a method is provided for fabricating a three-dimensional device. The method includes the steps of providing a container defining a chamber and filling the chamber with polymerizable material. A polymerizing agent is directed towards first and second portions of the polymerizable material.

A first mask may be positioned between the polymerizing agent and the first portion of the polymerizable material. A second mask may be positioned between the polymerizable agent and the second portion of the polymerizable material. It is contemplated to reposition the container prior to directing the polymerizing agent towards the second portion of the polymerizable material. Alternatively, the polymerizing agent may be directed towards the first portion of the polymerizable material along a first axis and towards the second portion of the polymerizable material along a second axis. The first axis and the second axis are at a predetermined angle to each other. The polymerizing agent directed towards the first portion of the polymerizable material may be generated by a first source and the polymerizing agent directed towards a second portion of the polymerizable material may be generated by a second source.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is an isometric view of a three-dimensional, microfluidic device fabricated in accordance with the method of the present invention;

FIG. 2 is an isometric view of a container, an optical mask, and a pair of ultraviolet light sources used to fabricate the microfluidic device of FIG. 1;

FIG. 3 is an end view of the microfluidic device of FIG. 1;

FIG. 4 is a front elevational view of a first optical mask used to fabricate the microfluidic device of FIG. 1;

FIG. 5 is a front elevational view of a second optical mask used to fabricate the microfluidic device of FIG. 1;

FIG. 6 is a cross-sectional view of the microfluidic device taken along line 6-6 of FIG. 1;

FIG. 7 is a cross-sectional view taken along line 7-7 of FIG. 2 showing the container filled with a polymerizable material; and

FIG. 8 is a schematic view showing an alternate method for fabricating the three-dimensional, microfluidic device of FIG. 1.

### DETAILED DESCRIPTION OF THE DRAWINGS

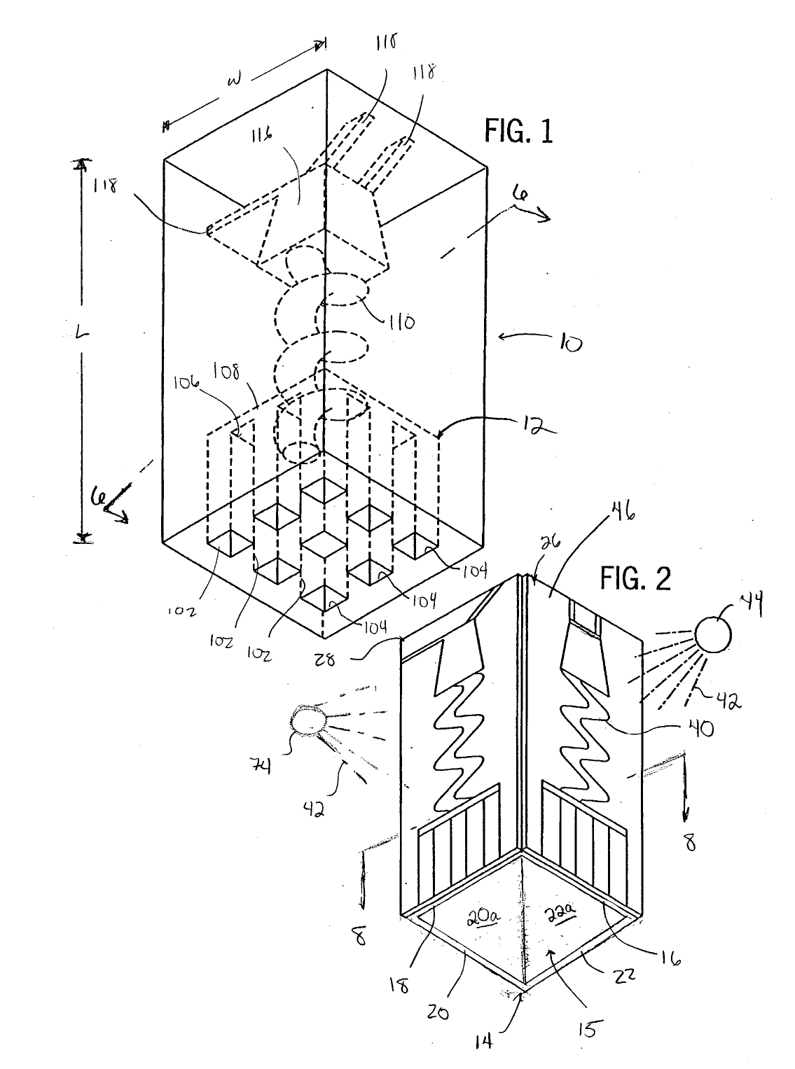

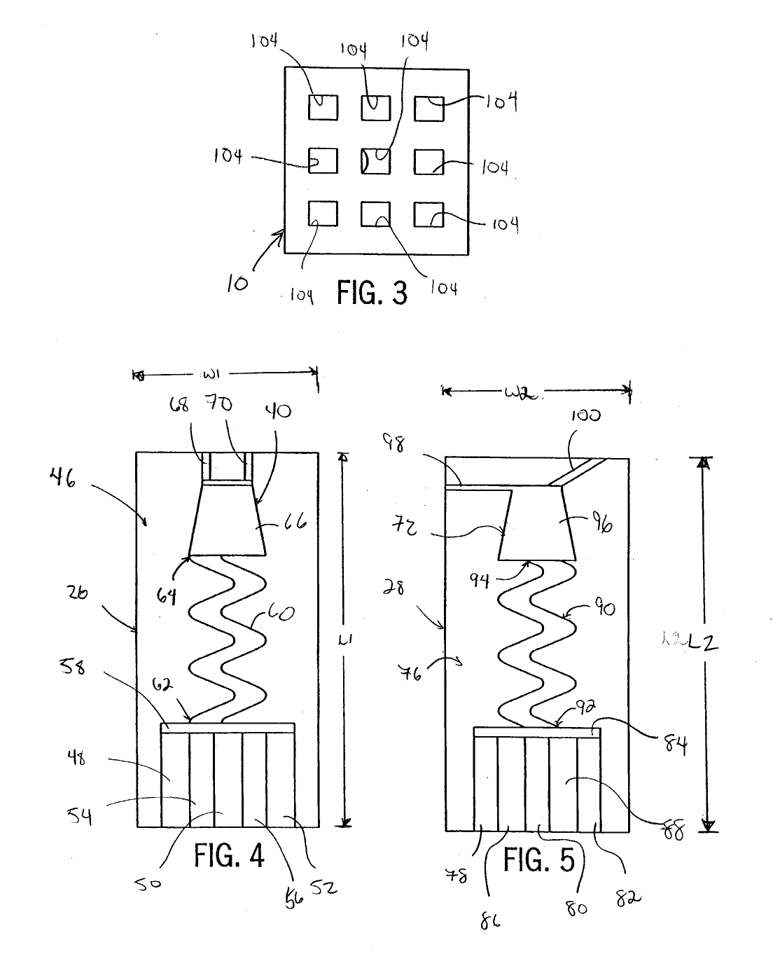

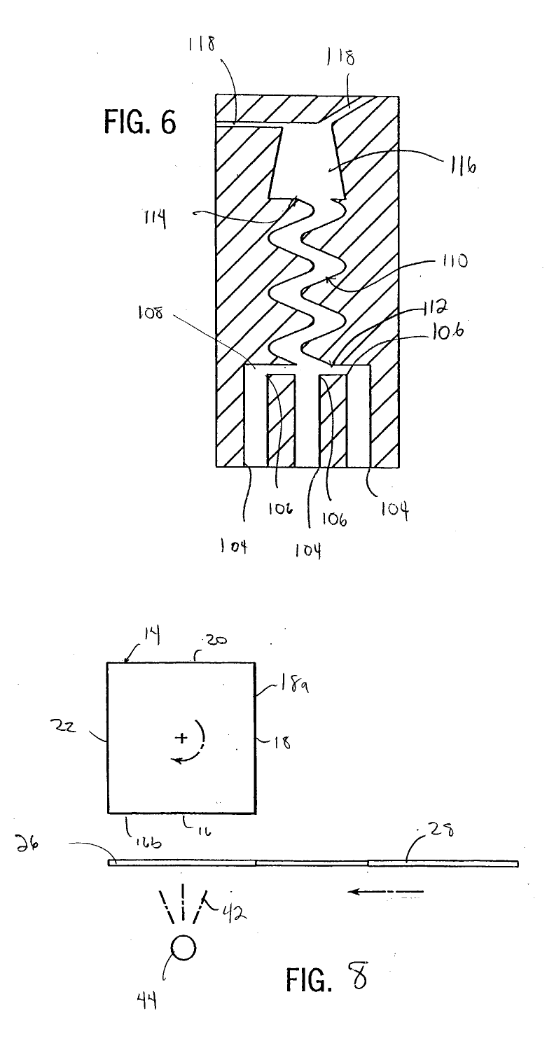

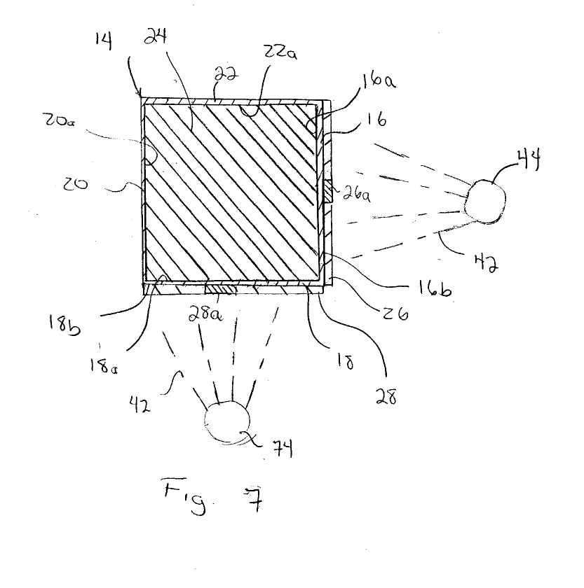

Referring to FIGS. 1 and 2, a microfluidic device fabricated in accordance with the methodology of the present invention is generally designated by the reference numeral 10. It is intended that microfluidic device 10 include a corresponding channel network 12, as hereinafter described, formed therein. Microfluidic device 10 is fabricated from polymerizable material 24, FIG. 7, deposited within cavity 15 formed within container 14. As best seen in FIGS. 2 and 7, container 14 is defined by sidewalls 16, 18, 20 and 22 and by a closed end wall (not pictured). Inner faces 16a, 18a, 20a and 22a of sidewalls 16, 18, 20 and 22, respectively, define cavity 15 for receiving polymerizable material 24 therein. Sidewalls 16, 18, 20 and 22 of container 14 are formed from a polymeric material that allows for a polymerizing agent such as ultraviolet light to pass therethrough, for reasons hereinafter described.

Referring to FIGS. 2, 4-5 and 7, optical masks 26 and 28 are affixed to corresponding outer surfaces 16b and 18b of sidewalls 16 and 18, respectively. Optical masks 26 and 28 include corresponding masking portions 40 and 72, respectively, having shapes corresponding to the desired configuration of channel network 12 to be formed in microfluidic device 10, as hereinafter described. In order to accurately position optical mask 26 on outer surface 16b of container 14, optical mask 26 has a length L1 generally equal to the length L of container 14 and a width W1 generally equal to the width W of container 14. Likewise, in order to accurately position optical mask 28 on outer surface 18a of container 14, optical mask 28 has a length L2 generally equal to the length L of container 14 and a width W2 generally equal to the width W of container 14.

Optical mask 26 includes masking portion 40 that shields a portion of polymerizable material 24 within cavity 15 in container 14 from ultraviolet light 42 generated by first ultraviolet light source 44 and non-masking portion 46 that allows ultraviolet light 42 to pass therethrough. Masking portion 40 of optical mask 26 includes a plurality of rectangular, generally parallel strips 48, 50 and 52 having inner ends interconnected by rectangular connection strip 58 that extends along an axis transverse to strips 48, 50 and 52. Generally rectangular, non-masking strip 54 of non-masking portion 46 is positioned between and separates strips 48 and 50 of masking portion 40. Similarly, generally rectangular non-masking strip 56 of non-masking portion 46 is positioned between and separates strips 50 and 52 of masking portion 40.

Masking portion 40 of optical mask 26 further includes sinusoidal-shaped strip 60 having first end 62 connected to connection strip 58 and second opposite end 64. Trapezoidal-shaped strip 66 of masking portion 40 is positioned at second end 64 of sinusoidal-shaped strip 60. First and second rectangular strips 68 and 70, respectively, of masking portion 40 of optical mask 26 extend from trapezoidal-shaped strip 66.

Optical mask 28 includes masking portion 72 that shields a portion of polymerizable material 24 within cavity 15 of container 14 from ultraviolet light 42 generated by second ultraviolet light source 74 and non-masking portion 76 that allows ultraviolet light 42 to pass therethrough. Masking portion 72 of optical mask 28 includes a plurality of rectangular, generally parallel strips 78, 80 and 82 having inner ends interconnected by rectangular connection strip 84 that extends along an axis transverse to strip 78, 80 and 82. Generally rectangular, non-masking strip 86 of non-masking portion 76 is positioned between and separates strips 78 and 80 of masking portion 72. Similarly, generally rectangular, non-masking strip 88 of non-masking portion 76 is positioned between and separates strips 80 and 82 of masking portion 72.

Masking portion 72 of optical mask 28 includes sinusoidal-shaped strip 90 having first end 92 connected to connection strip 84 and second opposite end 94. Trapezoidal-shaped strip 96 of masking portion 72 is positioned at second end 94 of sinusoidal-shaped strip 90. First and second strips 98 and 100, respectively, of masking portion 72 of optical mask 28 extend from trapezoidal shaped strip 96.

In operation, cavity 15 within container 14 is filled with polymerizable material 24. As is known, polymerizable material 24 polymerizes and solidifies when exposed to a polymerizing agent such as ultraviolet light 42, temperature or the like. Ultraviolet light 42 is generated by first ultraviolet light source 44 and directed towards container 14 at an angle generally perpendicular to outer surface 16b of sidewall 16. It can be appreciated masking portion 40 of optical mask 26 shields a first portion of polymerizable material 24 from ultraviolet light 42 generated by first ultraviolet light source 44. Non-masking portion 46 of optical mask 26 allows ultraviolet light 42 generated by first ultraviolet light source 44 to pass therethrough such that a second portion of the polymerizable material 24 in cavity 15 of container 14 is exposed to ultraviolet light 42 generated by first ultraviolet light source 44 and polymerizes.

Simultaneously or sequentially, ultraviolet light 42 generated by second ultraviolet light source 74 is directed towards sidewall 18 of container 14 at an angle generally perpendicular to outer surface 18b of sidewall 18. It can be appreciated that masking portion 72 of optical mask 28 shields a first portion of polymerizable material 24 from ultraviolet light 42 generated by second ultraviolet light source 74, while non-masking portion 76 of optical mask 28 allows ultraviolet light 42 generated by second ultraviolet light source 74 to pass therethrough such that a second portion of polymerizable material 24 is exposed to ultraviolet light 42 generated by second ultraviolet light source 74 and polymerizes. As described, the intersection of the portion of polymerizable material 24 shielded from ultraviolet light 42 generated by first ultraviolet light source 44 and the portion of the polymerizable material 24 shielded from ultraviolet light 42 generated by second ultraviolet light source 74 defines a volume of polymerizable material 24 in cavity 15 of container 14 that is not exposed to ultraviolet light 42, and as such, does not polymerize. This volume of polymerizable material 24 not exposed to ultraviolet light 42 has a shape corresponding to the desired configuration of channel network 12 to be formed in microfluidic device 10. The volume of polymerizable material 24 not exposed to ultraviolet light 42 is flushed from the interior of microfluidic device 10 to form channel network 12.

By way of example, channel network 12 includes a plurality of generally parallel, rectangular passageways 102 having input ends 104 and output ends 106 communicating with generally rectangular chamber 108. Serpentine-shaped tube 110 has an input end 112 communicating with rectangular chamber 108 and an output end 14 communication with pyramidal-shaped chamber 116. Output passageways 118 diverge from pyramidal shaped chamber 116. It can be appreciated that the configuration of channel network 12 fabricated within microfluidic device 10 may be altered by simply varying the sizes, dimensions or configurations of masking portions 40 and 72 of optical masks 26 and 28, respectively. As such, it can be appreciated that by employing the method of the present invention, channel networks of any user desired configuration are possible without deviating from the scope of the present invention.

Referring to FIG. 8, an alternate methodology for fabricating microfluidic device 10 is depicted. Cavity 15 in container 14 is filled with polymerizable material 24 and container 14 is positioned such that ultraviolet light 42 generated by the first ultraviolet light source 44 is directed towards container 14 at an angle generally perpendicular to outer surface 16b of sidewall 16 of container 14. Optical mask 26 is positioned between first ultraviolet light source 44 and sidewall 16 of container 14 such that masking portion 40 of optical mask 26 shields a first portion of polymerizable material 24 within cavity 15 of container 14 from ultraviolet light 42. A second portion of a polymerizable material 24 within cavity 15 of container 14 is exposed to ultraviolet light 42 passing through non-masking portion 46 of first optical mask 26 so as to polymerize and solidify.

Thereafter, container 14 is rotated 90° such that ultraviolet light 42 generated by first ultraviolet light source 44 is directed towards sidewall 18 of container 14 at an angle generally perpendicular to outer surface 18b of sidewall 18 of container 14. Simultaneously, second optical mask 28 is positioned between container 14 and first ultraviolet light source 44 such that masking portion 72 of optical mask 28 shields a first portion of polymerizable material 24 from ultraviolet light 42. A second portion of polymerizable material 24 within cavity 15 of container 14 is exposed to ultraviolet light 42 passing through non-masking portion 76 of optical mask 28 so as to polymerize and solidify.

It can be appreciated that the intersection of the portion of polymerizable material 24 shielded from the ultraviolet light 42 directed towards first optical mask 26 and the portion of polymerizable material shielded from ultraviolet light 42 directed towards second optical mask 28 define a volume of polymerizable material 24 in cavity 15 of container 14 that is not exposed to ultraviolet light 42, and as such, does not polymerize. This volume of polymerizable material 24 not exposed to ultraviolet light 42 has a shape corresponding to the desired configuration of channel network 12 to be formed in microfluidic device 10. The volume of polymerizable material not exposed to ultraviolet light 42 is flushed from the interior of microfludic device 10 to form channel network 12 therein.

In order to prevent convective mixing during polymerization of polymerizable material 24 and a subsequent loss of the resolution of channel network 12 in microfluidic device 10, it is necessary to polymerize polymerizable material 24 at relatively high radiation levels, e.g., approximately ˜150 MJ/cm². Alternatively, polymerizable material 24 of microfluidic device 10 may be polymerized at a low temperature to prevent convective mixing during polymerization, and yet, allow for the easy removal of the unpolymerized polymerizable material 24 from the channel network formed at mildly elevated temperatures. In addition, a photobleachable photoinitiator could be used to conduct polymerization in predetermined portions of microfludic device 10 or electron beam radiation could be used to polymerize polymerizable material 24 in order to reduce bending of the polymerizing agent and to aid in a more uniform, less stressful, through polymerization.

It can be appreciated that methodology of the present invention may be implemented using a plurality of optical masks with containers of any configuration receiving polymerizable material 24. Further, it can be understood that functional components may be fabricated within microfluidic device 10 by such techniques as polymerization mediated grafting of different polymers, polymerization of responsive hydrogels, and polymerization of porous filters.

Alternatively, ultraviolet light 42 may be generated by an ultraviolet light projector incorporating a digital micromirror device. The digital micromirror device utilizes an array of controllable digital micromirrors to selectively reflect light in pixel units. The ultraviolet light projector can be programmed such that the shape and the characteristics of the ultraviolet light 42 emanating from the ultraviolet light projector define a user desired pattern of ultraviolet light. Consequently, ultraviolet light 42 may be directed towards specific portions of microfluidic device 10, thereby rendering optical masks 26 and 28 unnecessary to practice the method of the present invention.

By way of example, container 14 may be positioned such that ultraviolet light 42 generated by the ultraviolet light projector incorporating a digital micromirror device is directed towards container 14 at an angle generally perpendicular to outer surface 16b of sidewall 16 of container 14. The ultraviolet light projector is programmed in such a manner as to control the patterning of ultraviolet light 42 directed towards microfluidic device 10 to correspond to the portion of ultraviolet light 42 that would have passed through optical mask 26, as heretofore described. As such, only a portion of polymerizable material 24 within cavity 15 of container 14 is exposed to ultraviolet light 42 generated by the ultraviolet light projector, and hence, polymerizes.

Thereafter, container 14 is rotated 90° such that ultraviolet light 42 generated by the ultraviolet light projector is directed towards sidewall 18 of container 14 at an angle generally perpendicular to outer surface 18b of sidewall 18 of container 14. Ultraviolet light 42 is projected by the ultraviolet light projector in such a manner as to control the patterning of ultraviolet light 42 directed towards microfluidic device 10 to correspond to the portion of ultraviolet light 42 the would have passed through second optical mask 28, as heretofore described. A second portion of polymerizable material 24 within cavity 15 of container 14 is exposed to ultraviolet light 42, and hence, polymerizes.

It can be appreciated that the intersection of the portion of polymerizable material 24 not exposed to ultraviolet light 42 directed towards sidewall 16 of container 14 and the portion of polymerizable material not exposed to the ultraviolet light 42 directed towards sidewall 18 of container 14 define a volume of polymerizable material 24 in cavity 15 of container 14 that is not exposed to ultraviolet light 42, and as such, does not polymerize. This volume of polymerizable material 24 not exposed to ultraviolet light 42 has a shape corresponding to the desired configuration of channel network 12 to be formed in microfluidic device 10. The volume of polymerizable material not exposed to ultraviolet light 42 is flushed from the interior of microfludic device 10 to form channel network 12 therein.

Various modes of carrying out the invention are contemplated as being within the scope of the following claims particularly pointing out and distinctly claiming the subject matter which is regarded as the invention.

We claim:

1. A method of fabricating a three-dimensional device, comprising the steps of:
providing a volume of polymerizable material, the volume having an outer surface;
directing a polymerizing agent towards a first portion of the outer surface; and
directing the polymerizing agent towards a second portion of the outer surface.

2. The method of claim 1 comprising the additional steps of:
positioning a first mask between the polymerizing agent and the first portion of he outer surface; and
positioning a second mask between the polymerizing agent and the second portion of the outer surface.

3. The method of claim 1 wherein the polymerizing agent is directed towards the first portion of the outer surface along a first axis, and wherein the polymerizing agent is directed towards the second portion of the outer surface along a second axis.

4. The method of claim 3 wherein the first axis and the second axis are at a predetermined angle to each other.

5. The method of claim 3 wherein the polymerizing agent directed towards the first portion of the outer surface is generated by a first source and wherein the polymerizing agent directed towards the second portion of the outer surface is generated by a second source.

6. The method of claim 1 wherein the step of directing a polymerizing agent towards a second portion of the outer surface includes the step of repositioning the outer surface of the volume.

7. A method of fabricating a three-dimensional device, comprising the steps of:
providing a container defining a chamber, the container having an outer surface;
filling the chamber with a polymerizable material; and
directing a polymerizing agent towards the container such that first and second portions of the outer surface of the container are exposed to the polymerizing agent.

8. The method of claim 7 comprising the additional steps of:
positioning a first mask between the polymerizing agent and the first portion of the outer surface of the container; and
positioning a second mask between the polymerizing agent and the second portion of the outer surface of the container.

9. The method of claim 7 wherein the polymerizing agent is directed towards the first portion of the outer surface along a first axis, and wherein the polymerizing agent is directed towards the second portion of the outer surface along a second axis.

10. The method of claim 9 wherein the first axis and the second axis are at a predetermined angle to each other.

11. The method of claim 7 wherein the polymerizing agent directed towards the first portion of the outer surface is generated by a first source and wherein the polymerizing agent directed towards the second portion of the outer surface is generated by a second source.

12. The method of claim 7 wherein the step of directing a polymerizing agent towards a second portion of the outer surface includes the step of repositioning the container after directing the polymerizing agent towards the first portion of the outer surface of the container.

13. A method of fabricating a three-dimensional device, comprising the steps of:
providing a container defining a chamber;
filling the chamber with a polymerizable material;
directing a polymerizing agent towards a first portion of the polymerizable material; and
directing a polymerizing agent towards a second portion of the polymerizable material.

14. The method of claim 13 comprising the additional steps of:
positioning a first mask between the polymerizing agent and the first portion of the polymerizable material; and
positioning a second mask between the polymerizing agent and the second portion of the polymerizable material.

15. The method of claim 14 wherein the polymerizing agent is directed towards the first portion of the polymerizable material along a first axis, and wherein the polymerizing agent is directed towards the second portion of the polymerizable material along a second axis.

16. The method of claim 16 wherein the first axis and the second axis are at a predetermined angle to each other.

17. The method of claim 13 wherein the polymerizing agent directed towards the first portion of the polymerizable material is generated by a first source and wherein the polymerizing agent directed towards the second portion of the polymerizable material is generated by a second source.

18. The method of claim 13 comprising the additional step of repositioning the container prior to directing a polymerizing agent towards a second portion of the polymerizable material.
